(19) United States
(12) Patent Application Publication
(10) Pub. No.: US 2014/0101915 A1
(43) Pub. Date: Apr. 17, 2014

(54) Loading/Unloading System for Printing Plates

(71) Applicant: MACDERMID PRINTING SOLUTIONS, LLC, Waterbury, CT (US)

(72) Inventors: David A. Recchia, Smyrna, GA (US); Ryan W. Vest, Cumming, GA (US); Albert Ohlig, Newport Beach, CA (US); Jim Hennessy, Woburn, MA (US); David X. Elwell, Kennesaw, GA (US)

(73) Assignee: MACDERMID PRINTING SOLUTIONS, LLC, Waterbury, CT (US)

(21) Appl. No.: 13/653,916

(22) Filed: Oct. 17, 2012

(51) Int. Cl. B65H 75/38; B23P 11/00; B65H 75/44

(52) U.S. Cl. 29/428; 242/407; 242/390; 242/397

(57) ABSTRACT

An apparatus for transferring a relief image printing blank between stations of a printing element manufacturing process and a method of using the same is described. The apparatus comprises a cylindrical mandrel for supporting the relief image printing element which includes means for securing the relief image printing blank to the mandrel. The mandrel is capable of transferring the relief image printing blank into and/or out of various stations of the printing element manufacturing process.

### FIELD OF THE INVENTION

The present invention relates generally to a mandrel system for loading and unloading printing plates during the manufacturing process.

### BACKGROUND OF THE INVENTION

Flexography is a method of printing that is commonly used for high-volume runs. Flexography is employed for printing on a variety of substrates such as paper, paperboard stock, corrugated board, films, foils and laminates. Newspapers and grocery bags are prominent examples. Coarse surfaces and stretch films can be economically printed only by means of flexography. Flexographic printing plates are relief plates with image elements raised above open areas. Such plates offer a number of advantages to the printer, based chiefly on their durability and the ease with which they can be made.

A typical flexographic printing plate as delivered by its manufacturer, is a multilayered article made of in order, a backing or support layer, one or more photocurable layers, a protective layer or slip film, and a cover sheet.

The photocurable layer(s) can include any of the known polymers, monomers, initiators, reactive and/or non-reactive diluents, fillers, and dyes. As used herein, the term “photocurable” refers to a composition which undergoes polymerization, cross-linking, or any other curing or hardening reaction in response to actinic radiation with the result that the unexposed portions of the material can be selectively separated and removed front the exposed (cured) portions to form a three-dimensional relief pattern of cured material. Exemplary photocurable materials are disclosed in European Patent Application Nos. 0 456 336 A2 and 0 640 878 A1 to Goss, et al., British Patent No. 1,366,769, U.S. Pat. No. 5,223,375 to Berrier, et al., U.S. Pat. No. 3,867,153 to MacLahan, U.S. Pat. No. 4,264,705 to Allen, U.S. Pat. Nos. 4,323,636, 4,323,637, 4,369,246, and 4,423,135 all to Chen, et al., U.S. Pat. No. 3,265,765 to Holden, et al., U.S. Pat. No. 4,320,188 to Heinz, et al., U.S. Pat. No. 4,427,759 to Gruetzmacher, et al. U.S. Pat. No. 4,622,088 to Min, and U.S. Pat. No. 5,135,827 to Bohm, et al., the subject matter of each of which is herein incorporated by reference in its entirety. More than one photocurable layer may also be used.

Photocurable materials generally cross-link (cure) and harden through radical polymerization in at least some actinic wavelength region. As used herein, “actinic radiation” is radiation that is capable of polymerizing, crosslinking or curing the photocurable layer. Actinic radiation includes, for example, amplified (e.g., laser) and non-amplified light, particularly in the UV and violet wavelength regions.

The slip film is a thin layer, which protects the photopolymer from dust and increases its ease of handling. In a conventional (“analog”) plate making process, the slip film is transparent to UV light, and the printer peels the cover sheet off the printing plate blank, and places a negative on top of the slip film layer. The plate and negative are then subjected to flood-exposure by UV light through the negative. The areas exposed to the light cure, or harden, and the unexposed areas are removed (developed) to create the relief image on the printing plate.

In a “digital” or “direct to plate” process, a laser is guided by an image stored in an electronic data file, and is used to create an in situ negative in a digital (i.e., laser ablatable) masking layer, which is generally a slip film which has been modified to include a radiation opaque material. Portions of the laser ablatable layer are then ablated by exposing the masking layer to laser radiation at a selected wavelength and power of the laser. Examples of laser ablatable layers are disclosed, for example, in U.S. Pat. No. 5,925,500 to Yang, et al., and U.S. Pat. Nos. 5,262,275 and 6,238,837 to Fan, the subject matter of each of which is herein incorporated by reference in its entirety.

Processing steps for forming relief image printing elements typically include the following:
1) Image generation, which may be mask ablation for digital “computer to plate” printing plates or negative production for conventional analog plates;
2) Back exposure to create a floor layer in the photocurable layer and establish the depth of relief;
3) Face exposure through the mask (or negative) to selectively crosslink and cure portions of the photocurable layer not covered by the mask, thereby creating the relief image;
4) Development to remove unexposed photopolymer (e.g., by solvent development, water development or thermal development); and
5) if necessary, post exposure and detackification.

Removable coversheets may also be provided to protect the photocurable printing element from damage during transport and handling. Prior to processing the printing elements, the coversheet is removed and the photosensitive surface is exposed to actinic radiation in an imagewise fashion. Upon imagewise exposure to actinic radiation, polymerization, and hence, insolubilization of the photocurable layer occurs in the exposed areas. Treatment with a suitable developer solvent (or alternatively, thermal development) removes the unexposed (i.e., uncured) areas of the photocurable layer, leaving behind a cured printing relief that can be used for flexographic printing.

As used herein “back exposure” refers to a blanket exposure to actinic radiation of the photopolymerizable layer on the side opposite that which does, or ultimately will, bear the relief. This step is typically accomplished through a transparent support layer and is used to create a shallow layer of photocured material, i.e., the “floor,” on the support side of the photocurable layer. The purpose of the floor is generally to sensitize the photocurable layer and to establish the depth of relief.

Following the brief back exposure step (i.e., brief as compared to the imagewise exposure step which follows), an imagewise exposure is performed utilizing a digitally-imaged mask or a photographic negative mask, which is in contact with the photocurable layer and through which actinic radiation is directed.

The type of radiation used is dependent on the type of photoinitiator in the photopolymerizable layer. The digitally-imaged mask or photographic negative prevents the material beneath from being exposed to the actinic radiation and hence those areas covered by the mask do not polymerize, while the areas not covered by the mask are exposed to actinic radiation and polymerize. Any conventional sources of actinic radiation can be used for this exposure step, including, for example, carbon arcs, mercury-vapor arcs, fluorescent lamps, electron flash units, electron beam units, LEDs and photographic flood lamps.

After imaging, the photosensitive printing element is developed to remove the unpolymerized portions of the photocurable layer and reveal the crosslinked relief image therein. The resulting surface has a relief pattern, which typically comprises a plurality of dots that reproduces the image to be printed. After the relief image is developed, the resulting relief image printing element may be mounted on a press and printing commenced. In addition, if necessary, the relief image printing element may be post exposed and/or detackified after the development step, as is generally well known in the art.

It is highly desirable in the flexographic prepress printing industry to eliminate the need for chemical processing of printing elements in developing relief images, in order to go from plate to press more quickly. Processes have been developed whereby photopolymer printing plates are prepared using heat and the differential melting temperature between cured and uncured photopolymer is used to develop the latent image. The basic parameters of this process are known, as described in U.S. Pat. Nos. 5,279,697, 5,175,072 and 3,264,103, in published U.S. Pat. Pub. Nos. US 2003/0180655, and U.S. 2003/0211423, and in WO 01/88615, WO 01/18604, and EP 1239329, the teachings of each of which are incorporated herein by reference in their entirety. These processes allow for the elimination of development solvents and the lengthy plate drying times needed to remove the solvent. The speed and efficiency of the process allow for use of the process in the manufacture of flexographic plates for printing newspapers and other publications where quick turnaround times and high productivity are important.

In thermal development, uncured portions of the photocurable layer are softened (or melted) by passing the printing element over a heated roller and the softened portions are then removed, such as by contacting the heated printing element with a material that will absorb or otherwise remove the softened portions of the photocurable layer to reveal the relief image. The composition of the photocurable material should be such that there exists a substantial difference in the melt temperature between the cured and uncured photocurable material, which allows for the creation of an image in the photocurable layer when heated. The uncured photocurable layer (i.e., the portions of the photocurable layer not contacted with actinic radiation) will melt or substantially soften while the cured photocurable layer will remain solid and intact at the temperature chosen. Thus the difference in melt temperature allows the uncured photocurable material to be selectively removed, thereby creating an image.

Depending on their size, photocurable relief image printing elements can be unwieldy to handle and thus may be easily damaged when transferring between the various stages of the printing plate manufacturing process. Thus, it would be desirable to provide an improved transferring means for moving relief image printing elements between the various stages of the printing plate manufacturing process.

### SUMMARY OF THE INVENTION

It is an object of the present invention to reduce the time required to load/unload relief image printing plates at the various stations in a flexographic printing plate manufacturing process.

It is still another object of the present invention to reduce the likelihood of damage caused by creasing, nicking, scratching, or otherwise marring of a surface of the relief image printing element during movement of the printing element through the manufacturing process.

It is still another object of the present invention to increase the ease of handling oversized relief image printing elements during the manufacturing process.

To that end, in one embodiment the present invention relates generally to an apparatus for transferring a relief image printing blank between stations of a printing element manufacturing process, wherein the relief image printing blank comprises at least one photocurable layer disposed on a backing layer, the apparatus comprising:

a cylindrical mandrel for supporting the relief image printing element,

wherein said mandrel comprises means for securing the relief image printing blank to the mandrel, and

wherein said mandrel is capable of transferring the relief image printing blank into and/or out of a station of the printing element manufacturing process.

In another embodiment, the present invention relates generally to a method of transferring a relief image printing blank between stations of a printing element manufacturing process, wherein the relief image printing blank comprises at least one photocurable layer disposed on a backing layer, the method comprising the steps of:

retaining a relief image printing blank on a cylindrical mandrel; and

transferring the mandrel with the relief image printing blank retained thereon into and/or out of a station in the relief image printing element manufacturing process.

### BRIEF DESCRIPTION OF THE FIGURES

The present invention will be more fully understood when read in combination with the following drawings, in which:

FIG. 1 depicts a mandrel for transferring relief image printing elements in accordance with the present invention.

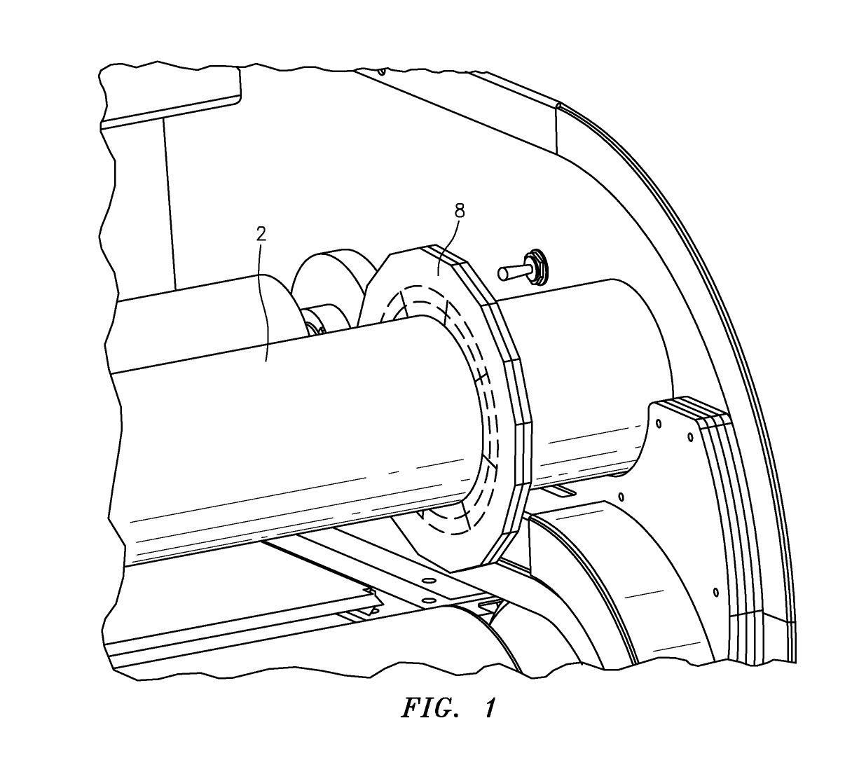

FIG. 2 depicts a top view of a mandrel in accordance with the present invention that is mounted in a thermal processor.

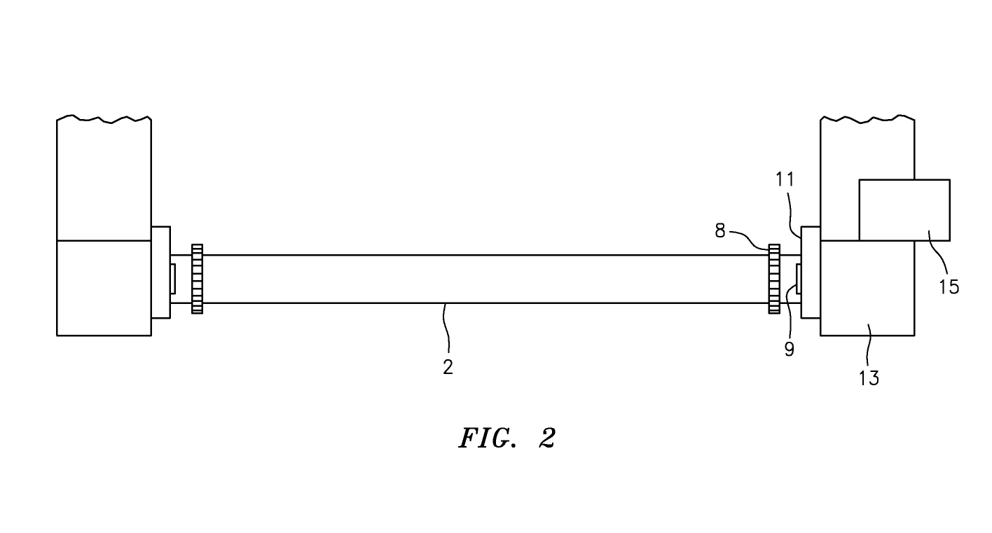

FIG. 3 depicts a side view of a mandrel in accordance with the present invention as mounted adjacent to a conveyor system of a thermal processor.

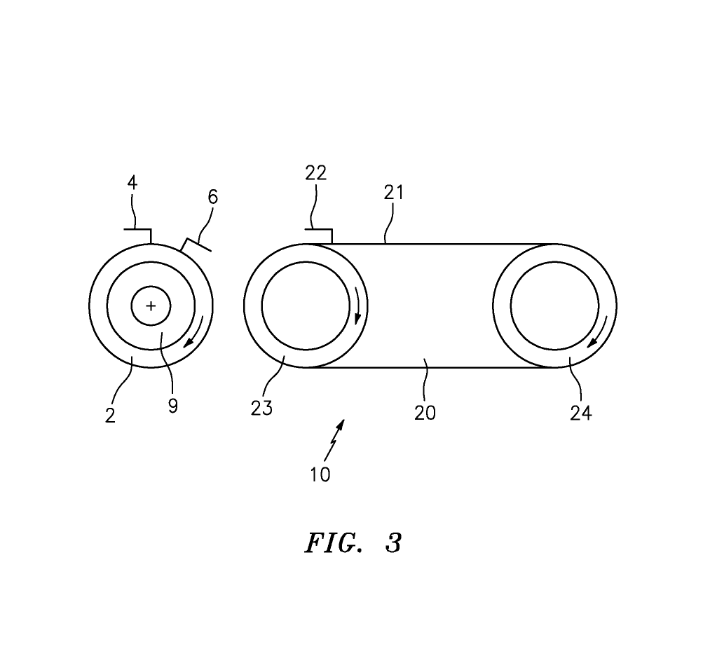

FIG. 4 depicts another view of a mandrel mounted adjacent to a thermal processor system in accordance with the present invention.

Also, while not all elements may be labeled in each figure, all elements with the same reference number indicate similar or identical parts.

### DETAILED DESCRIPTION OF THE PREFERRED EMBODIMENTS

The present invention relates generally to a transfer system for transferring relief image printing elements between the various stages of a printing plate manufacturing process. The stages of the printing plate manufacturing process may include, for example, an imaging and exposing apparatus, a development apparatus, and a post exposure and/or detackification apparatus. The development apparatus may be a thermal processor for thermally developing the relief image printing plate. Other stages/process steps would also be known to those skilled in the art and the transfer system described herein would also be usable with these other stages/processing steps.

In one embodiment, the transfer system is used for transferring large or oversize relief image printing elements into and out of a thermal processor. Thus, as described herein, the present invention relates generally to a transfer system for use with a thermal processor and a method of using the transfer system to more easily move relief image printing elements into (and out of) the thermal processor.

More specifically, and as depicted in the Figures, the present invention relates generally to an apparatus for transferring a relief image printing blank (14) between stations of a printing element manufacturing process, wherein the relief image printing blank (14) comprises at least one photocurable layer disposed on a backing layer, the apparatus comprising:

a cylindrical mandrel (2) for supporting the relief image printing blank (14),

wherein said mandrel (2) comprises means for securing (4,6) the relief image printing blank (14) to the mandrel (2), and

wherein said mandrel (2) is capable of transferring the relief image printing blank (14) into and/or out of a station of the printing element manufacturing process.

In one embodiment, the cylindrical mandrel (2) comprises one or more shaped end collars (8) arranged on at least one end of the cylindrical mandrel (2) to prevent the cylindrical mandrel (2) from rolling. These shaped end collars (8) may be spring loaded or otherwise movably mounted on the mandrel (2) to accommodate different sized printing plates.

The means for retaining (4,6) the relief image printing blank (14) on the mandrel (2) may comprise various means for removably attaching a sheet material to an underlying support means, including, for example, a vacuum, one or more clamps, a beveled divot, tape, one or more slots and combinations of one or more of the foregoing. In addition, various types of clamps can be used, including for example, hydraulic clamps, vacuum clamps, mechanical and electromechanical clamps. However, while it is necessary that the printing blank be securely attached to the mandrel to avoid any potential damage to the printing blank that could arise if the printing blank prematurely disengages from the mandrel, the placement of the printing blank on the mandrel need not be exact because the mandrel is only for transferring the printing blank between the stages of the manufacturing process.

The cylindrical mandrel (2) may be made of various materials so long as the mandrel (2) does not significantly bend or flex. In one embodiment, the cylindrical mandrel (2) is constructed of a hard plastic and/or metal. The mandrel (2) must have a diameter large enough to support a printing element of a desired size without any overlap and without causing damage to the printing element.

The apparatus described herein also comprises an adaptor (9) arranged on at least one end of the cylindrical mandrel (2) that is couplable to a support (11) in a loading or unloading area to removably secure the cylindrical mandrel (2) to the support in the loading or the unloading area. The adaptor (9) allows the cylindrical mandrel (2) to rotate in at least one of a clockwise or a counterclockwise direction. Thus, the cylindrical mandrel (2) can be coupled to the support (11) so that a relief image printing blank (14) can be wound onto the cylindrical mandrel (2) or unwound from the cylindrical mandrel (2).

In one embodiment, the loading area for loading the relief image printing blank (14) onto the cylindrical mandrel (2) is located separate from the stage of the printing plate manufacturing process.

In another embodiment, the unloading area for unloading the relief image printing blank (14) from the cylindrical mandrel (2) and into the station of the printing plate manufacturing process is positioned immediately adjacent to or within the station of the printing plate manufacturing process.

Also, while it is contemplated that the relief image printing blank (14) may be manually wound onto the cylindrical mandrel (2) or manually unwound from the cylindrical mandrel (2), in one embodiment this process is automated. Thus, in one embodiment, the cylindrical mandrel is operatively connected to a motor (13) which rotationally drives the cylindrical mandrel (2), wherein the motor (13) is controlled by a programmable controller (15), whereby the relief image printing blank (14) can be automatically wound onto or unwound from the cylindrical mandrel (2).

Furthermore, the cylindrical mandrel (2) may be operatively connected to at least one of a slip clutch, a torque control or a speed match. Various slip clutch, torque control and speed match devices are generally known in the art and would be usable in the present invention. Examples of these devices are described in U.S. Pat. No. 4,560,050 to deMey, II, and U.S. Pat. No. 4,363,455 to Del Bianco et al., which are herein incorporated by reference in their entirety.

In one embodiment, the printing plate manufacturing station is a thermal processor. In this instance, the support (11) is positioned in the thermal processor and the cylindrical mandrel (2) is removably securable in the thermal processor for unloading the relief image printing blank (14) into the thermal processor (10).

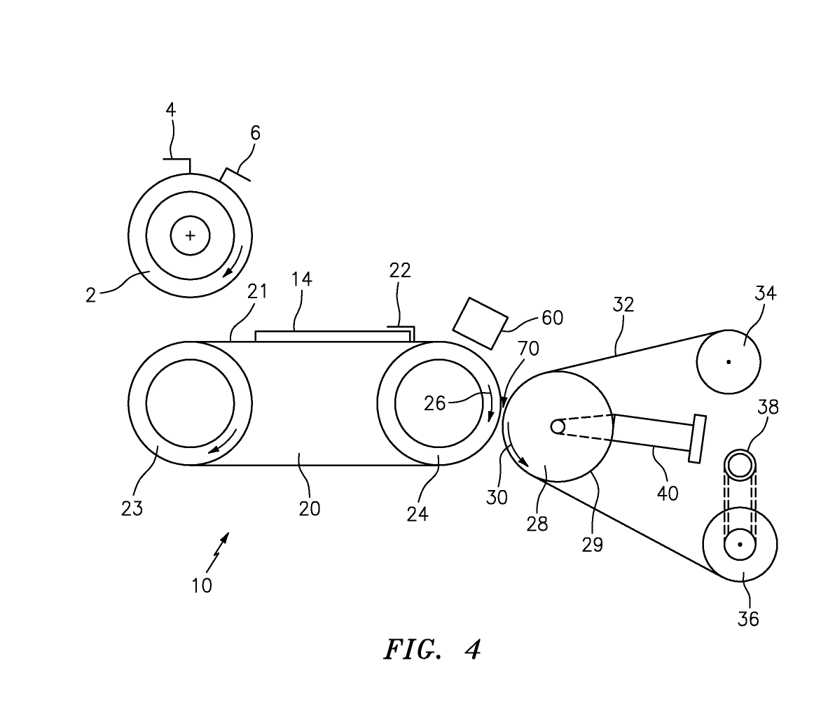

The thermal processor may also comprise an alignment element for aligning the relief image printing blank (14) with a conveyor (20) in the thermal processor as the relief image printing blank (14) is unwound from the cylindrical mandrel (2) into the thermal processor (10). It is also noted that while a thermal processor (10) is shown in FIG. 4 with a conveyor (20) for transporting the relief image printing blank (14) through the thermal processor (10), other configurations would be usable in the manner described herein. Furthermore, the location of the cylindrical mandrel (2) in the thermal processor (10) is a matter of design choice and while the cylindrical mandrel (2) is shown mounted above the conveyor (20), other configurations in which the cylindrical mandrel (2) is mounted adjacent to the conveyor (21) or beneath the conveyor (20) could also be used.

The present invention also relates generally to a method of transferring a relief image printing blank between stations of a printing element manufacturing process, wherein the relief image printing blank comprises at least one photocurable layer disposed on a backing layer, the method comprising the steps of:

retaining a relief image printing blank on a cylindrical mandrel; and

transferring the mandrel with the relief image printing blank retained thereon into and/or out of a station in the relief image printing element manufacturing process.

The method comprises the step of winding the relief image printing blank onto the cylindrical mandrel and thus uses the mandrel as a carrier to move the printing blank from one station to the next station in the manufacturing process. As described above, the step of winding the relief image printing blank onto the cylindrical mandrel may be performed manually or automatically in which a motor is used to rotationally drive the cylindrical mandrel.

Once the mandrel with the relief image printing blank secured thereon has been transferred into the station in the manufacturing process, the relief image printing blank can be unwound from the cylindrical mandrel and secured into the station in the manufacturing process.

In one embodiment, as described herein, the printing plate manufacturing station is a thermal processor. Immediately prior to removal of the non-crosslinked portions of the photopolymer layer in the thermal processor, the flexographic printing element is selectively exposed to actinic radiation to selectively crosslink and cure portions of the flexographic printing element to create the relief image. Thus, during the loading step, the relief image printing blank (14) may be pre-loaded on the mandrel (2) at the exposure unit and carried over to the thermal processor. Thereafter, the printing element is transferred to the thermal processor (10) to thermally develop the printing element to reveal the cured relief image therein.

During unloading, the plate is unclamped, with now unclamped edge being placed on the mandrel. The plate can then be positioned on the mandrel. Various means can be used for positioning the plate on the mandrel including, for example, tape, a beveled divot in the mandrel, or one or more clamps. The mandrel is then rotated to roll (or wind) the printing plate onto the mandrel. Again, this reduces any chance of the plates getting nicked, scratched or creased during handling, especially the handling of full-sized sheets. The rolled plate can then be delivered to a table or to a post-exposure unit and unrolled.

The relief image printing blank is unwound from the cylindrical mandrel and clamped or otherwise attached to the conveyor to convey the relief image printing blank through the thermal processor to remove melted or softened non-crosslinked photopolymer and reveal the cured relief image therein. The end of the plate may be clamped or otherwise attached to the conveyor while the plate begins processing and the conveyor is moving, whereby the plate unwinds from the mandrel and is immediately processed in the thermal processor. This eliminates bulky plate handling and reduces the possibility of plate damage or dirt accumulation on the plate.

As described above, an alignment means may be provided to align the relief image printing blank with the conveyor in the thermal processor as the relief image printing blank is unwound from the cylindrical mandrel.

FIG. 4 depicts a thermal processor (10) with a mandrel (2) mounted adjacent to the conveyor (21). As described above, the thermal processor (10) accepts a previously formed and imagewise actinic radiation exposed relief image printing blank (14). Examples of suitable relief image printing blanks are described in U.S. Pat. No. 5,175,092 to Martens, U.S. Pat. Nos. 5,262,275 and 6,238,837 to Fan, and U.S. Pat. Nos. 5,925,500 and 6,605,410 to Yang et al., the subject matter of each of which is herein incorporated by reference in its entirety.

FIG. 4 depicts a conveyor (20) attached to a drive motor that is used to transport and convey the relief image printing blank (14) through the thermal processor (10). The conveyor (20) is mounted in a fixed position and comprises a continuous loop (21) supported by at least a first roller (23) and a second roller (24). Optionally, one or more additional rollers may be used to provide additional support to the conveyor (20) and prevent the continuous loop (21) from sagging from the weight of the relief image printing blank (14).

The leading edge of the relief image printing blank (14) is secured to and held in place against the continuous loop (21) of the conveyor (20) by suitable fastening means (22), such as one or more clamps and/or a vacuum.

During operation, the conveyor (20) with the relief image printing blank (14) mounted thereon moves in a first direction (26) towards heatable roller (28) such that the relief image printing blank (14) passes through a gap (70) between the conveyor (20) and the heatable roller (28) as the continuous loop (21) of conveyor (20) rotates over and around the second roller (24). Heatable roller (28) rotates in an opposite direction (30) from the conveyor (20). Heatable roller (28) is capable of being urged towards the relief image printing blank (14) positioned on the conveyor (20) as the conveyor moves in first direction (26) and heatable roller (28) moves in an opposite direction (30).

In one embodiment, the heatable roller (28) is urged toward the relief image printing blank (14) on the conveyor (20) using suitable means, such as one or more pneumatic cylinders (40). The pneumatic cylinder(s) (40) positions the heatable roller (28) at a preset distance from the outer surface of the second roller (24) of the conveyor (20) to produce the gap (70) through which the relief image printing blank (14) passes as it travels on the continuous loop (21) of the conveyor (20) around the second roller (24). The pneumatic cylinder (40) is controlled to adjust the gap (70) depending on the thickness of the relief image printing blank (14).

A web of absorbent material (32) is conducted over at least a portion of an outer surface (29) of the heatable roller (28), which is capable of absorbing (removing) material that is liquefied or softened from the relief image printing blank (14) when the heatable roller (28) rotates and is heated and the web of absorbent material (32) contacts at least a portion of the relief image printing blank (14). The heatable roller (28) rotates in a direction (30) opposite to the direction (26) of the conveyor (20) so that the relief image printing blank (14) and the web of absorbent material (32) can be contacted with each other and then separated.

Heat may be provided to the heatable roller (28) by a core heater, or a focused IR heater, that is capable of maintaining a skin temperature of the heatable roller (28) that will soften or liquefy at least a portion of the photosensitive material. The temperature to which the heatable roller (28) is heated is chosen based on the composition of the photosensitive material and is based on the melting temperature of the monomers and polymers contained within the photosensitive material. Other sources of heat, including, but not limited to, steam, oil, and hot air, may also provide the desired skin temperature. The web of absorbent material (32) is supplied to at least the portion of the outer surface of the heatable roller (28) from a supply roll (34) of the web of absorbent material (32).

The web of absorbent material (32) comes into face-to-face contact with the heatable roller (28), which is typically heated to and maintained at a temperature between about 150° C. and about 250° C., depending in part on the melting temperature of the web of absorbent material (32). The temperature of the heatable roller (28) must also be low enough so that when the web of absorbent material (32) is not moving and the portions of the web of absorbent material (32) contacting the heatable roller (28) are at rest, the absorbent material (32) does not melt. Suitable means for maintaining uniform tension in the web of absorbent material throughout the system may be used, including for example, one or more idler rollers. Other means for maintaining tension in the web may also be provided and would be known to those skilled in the art.

It is generally preferred that the linear speed of the heatable roller (28), the web of absorbent material (32), and the relief image printing blank (14) be substantially the same to avoid any shear stress on the relief image printing blank (14), which stress is known to cause uneven relief portion plate thickness.

A take-up roller (36) may be provided for winding the web of absorbent material (32) after processing through the plate processor. The take-up roller (36) may be independently belt driven by a motor (38), which is preferably a variable speed motor. The speed of the motor (38) is adjusted so as to not interfere with the selected web tension, in order to avoid potential issues with printing plate quality.

Thus, it can be seen that the present invention increases the ease of handling oversized relief image printing elements during the manufacturing process. In addition, the process describe herein also reduces the likelihood of damage caused by creasing, nicking, scratching, or otherwise marring of a surface of the relief image printing element during movement of the printing element through the manufacturing process.

What is claimed:

1. An apparatus for transferring a relief image printing blank between stations of a printing element manufacturing process, wherein the relief image printing blank comprises at least one photocurable layer disposed on a backing layer, the apparatus comprising:
a cylindrical mandrel for supporting the relief image printing element,
wherein said mandrel comprises means for securing the relief image printing blank to the mandrel, and
wherein said mandrel is capable of transferring the relief image printing blank into and/or out of a station of the printing element manufacturing process.

2. The apparatus according to claim 1, wherein the cylindrical mandrel comprises one or more shaped end collars arranged on at least one end of the cylindrical mandrel, whereby the cylindrical mandrel is prevented from rolling.

3. The apparatus according to claim 2, wherein the shaped end collars are movably mounted on the cylindrical mandrel.

4. The apparatus according to claim 1, wherein the means for securing the relief image printing blank to the cylindrical mandrel comprises one or more clamps, a beveled divot, tape, or one or more slots.

5. The apparatus according to claim 1, comprising an adaptor arranged on at least one end of the cylindrical mandrel that is couplable to a support in a loading or unloading area for removably securing the cylindrical mandrel to the loading or the unloading area,
wherein the adaptor allows the cylindrical mandrel to rotate in at least one of a clockwise or a counterclockwise direction;
whereby the cylindrical mandrel can be coupled to the support so that a relief image printing blank can be wound onto the cylindrical mandrel or unwound from the cylindrical mandrel.

6. The apparatus according to claim 5, wherein the loading area is separate from the station in the printing plate manufacturing process.

7. The apparatus according to claim 5, wherein the unloading area is positioned immediately adjacent to or within the station of the printing plate manufacturing process.

8. The apparatus according to claim 5, wherein the cylindrical mandrel is operatively connected to a motor which rotationally drives the cylindrical mandrel, wherein the motor is controlled by a programmable controller, whereby the relief image printing element can be automatically wound onto or unwound from the cylindrical mandrel.

9. The apparatus according to claim 8, wherein the cylindrical mandrel is operatively connected to at least one of a slip clutch, a torque control or a speed match.

10. The apparatus according to claim 5, wherein the printing plate manufacturing station is a thermal processor.

11. The apparatus according to claim 10, wherein the support is positioned in the thermal processor and the cylindrical mandrel is removably securable in the thermal processor.

12. The apparatus according to claim 11, wherein the thermal processor comprises an alignment element capable of aligning the relief image printing blank with a conveyor in the thermal processor.

13. A method of transferring a relief image printing blank between stations of a printing element manufacturing process, wherein the relief image printing blank comprises at least one photocurable layer disposed on a backing layer, the method comprising the steps of:
retaining a relief image printing blank on a cylindrical mandrel; and
transferring the mandrel with the relief image printing blank retained thereon into and/or out of a station in the relief image printing element manufacturing process.

14. The method according to claim 13, comprising the step of winding the relief image printing blank onto the cylindrical mandrel.

15. The method according to claim 14, wherein the step of winding the relief image printing blank onto the cylindrical mandrel is performed manually.

16. The method according to claim 14, wherein the winding step is performed automatically.

17. The method according to claim 16, comprising the step of using a motor to rotationally drive the cylindrical mandrel, wherein the motor is controlled by a programmable controller, whereby the relief image printing element is automatically wound onto the cylindrical mandrel.

18. The method according to claim 14, comprising the step of unwinding the relief image printing blank from the cylindrical mandrel and securing the relief image printing blank into the station in the manufacturing process.

19. The method according to claim 18, wherein the printing plate manufacturing station is a thermal processor.

20. The method according to claim 19, wherein the support is positioned in the thermal processor and the cylindrical mandrel is removably secured in the thermal processor for unloading the relief image printing blank into the thermal processor.

21. The method according to claim 20, comprising the step of aligning the relief image printing blank with a conveyor in the thermal processor as the relief image printing blank is unwound from the cylindrical mandrel into the thermal processor.
